(19) United States
(12) Patent Application Publication
(10) Pub. No.: US 2016/0227760 A1
(43) Pub. Date: Aug. 11, 2016

(54) WILD TURKEY GAME CALL

(71) Applicant: Paul Peoples, Ardmore, AL (US)

(72) Inventor: Paul Peoples, Ardmore, AL (US)

(21) Appl. No.: 14/975,724

(22) Filed: Dec. 19, 2015

Related U.S. Application Data
(60) Provisional application No. 62/114,686, filed on Feb. 11, 2015.

(51) Int. Cl. A01M 31/00

(52) U.S. Cl. CPC A01M 31/004

(57) ABSTRACT

A game call that produces a sound that attracts wild turkey. Said wild turkey game call comprises a cylindrical member that houses a movable a stem member that produces the sound when the stem member is moved up and down within the cylindrical housing. The wild turkey game call may be placed within a gripping means of a game call holder so that the movable stem is moved up and down when the game call holder is remotely activated by a user.

### CROSS-REFERENCE TO RELATED APPLICATIONS

This application claims the benefit of the priority to provisional application No. 62/114,686 titled “Wild Turkey Game Call” filed with the United States Patent and Trademark Office on Feb. 11, 2015, the disclosure of which is incorporated herein by reference as if fully set forth herein.

### STATEMENT REGARDING FEDERALLY SPONSORED RESEARCH OR DEVELOPMENT

Not Applicable.

### THE NAMES OF THE PARTIES TO A JOINT RESEARCH AGREEMENT

Not applicable.

### INCORPORATION-BY-REFERENCE OF MATERIAL SUBMITTED ON A COMPACT DISC OR AS A TEXT FILE VIA THE OFFICE ELECTRONIC FILING SYSTEM

Not applicable.

### STATEMENT REGARDING PRIOR DISCLOSURES BY THE INVENTOR OR JOINT INVENTOR

The inventor did not disclosed the invention herein prior to the 12 month period preceding the filing of his provisional application.

### BACKGROUND OF THE INVENTION

1. Field of the Invention

The present invention relates to a game call that attracts wild turkeys and a game call holder that a hunter can use to remotely operate said wild turkey game call to attract wild turkey.

2. Description of Related Art

Numerous devices are known in the relevant art for use by hunters and others for producing game and/or predator calls and sounds in order to attract the game and/or predator to the source of the game call. These devices are known as game and/or predator calls and are widely available commercially. Although game calls for deer are typically cylindrical can calls, several devices have been disclosed that include a reed mechanism. Hall (U.S. Pat. No. 5,975,978) and Weiser (U.S. Pat. No. 6,053,794) discloses game call devices that include reed mechanisms. Bird and water fowl game calls usually include a reed or other sound-producing member and, are typically actuated by air. The reed devices require a hunter to blow air into the device to produce the bird or water fowl attracting noise. Hafford (U.S. Pat. No. 6,120,341) and Knight et al. (U.S. Pat. No. 4,888,903) disclose devices for attracting birds and water fowl wherein a user blows air across a reed, forcing the reed to vibrate, creating a sound to attract the wild birds and/or water fowl. Primos (U.S. Pat. No. 6,575,804 B1) discloses a game call for attracting wild animals that includes both a reed mechanism and a bellows mechanism for creating the attracting sounds. But, each of these prior art reed devices are difficult to use because a user must be well practiced in order to produce calls having realistic characteristics, such as the proper duration and sound level to attract a particular species of bird or water fowl. If the call is unrealistic, then game may be scared away rather than attracted to the call.

Other types of calls require a hunter to rub or strike an object against another object. It is difficult for a hunter to physically rub or strike objects, to produce an authentic call sound maintaining control of a weapon. Vaicunas et al. (U.S. Pat. No. 6,902,463 B2) discloses a game call device for attracting turkeys wherein a user rubs a member upon the surface of a slate-type surface to produce a sound for attracting wild turkeys. The device of Vaicunas et al. (U.S. Pat. No. 6,902,463 B2) requires a user to use both hands-one hand holds the slate-type surface and one hand grips the rubbing member-at the same time to produce the sound that attracts wild turkeys. Electronic calls effectively simulate game noises but are illegal while hunting migratory birds such as wild turkey. Galfidi, Jr. (U.S. Pat. No. 5,964,054) discloses a wild game animal and waterfowl attracting device that comprises a tape recorder that plays and amplifies sounds that attract wild game animals. This device is illegal in most areas of the United States.

Can calls are cylindrical devices that produce a game/predator noise when inverted or rotated from a right-side-up to an upside-down position. While can calls can reliably produce game noises, they require the hunter to manipulate the call while maintaining control of a weapon (Kirby U.S. Pat. No. 7,927,172 B1, Simone US 2006/0246815 A1, and Weider US 2008/0274666 A1). Another disadvantage associated with each of these devices is that the game/predator call originates from the hunter's location, which attracts the game/predator to the hunter which permits the game/predator to identify the hunter via sight and smell and avoid the call. This invention permits the remote operation of the can call so that the game/predator does not associate the call with the hunter and, therefore, improves the performance of the can call.

To date, no device has been disclosed that mechanically produces a noise that attracts a turkey and can be remotely operated. Most states require that any game call utilized to attract wild birds, including wild turkey, must be mechanically produced. Mechanical production of game call noises is difficult to do and is prone to attract wild game to the hunter's location which may include the hunter's smell. Remote operation allows a turkey hunter to position the call securely in the ground with him maintaining a distance away from the invention so that he can disguise his presence and location from the turkey while remaining within target range of a wild turkey.

### BRIEF DESCRIPTION OF THE SEVERAL VIEWS OF THE DRAWINGS

FIG. 1 illustrates a side view of the Wild Turkey Game Call with detachable gripping arm and a detachable turkey call.

FIG. 2 illustrates the top view of the Wild Turkey Game Call without any attachments.

FIG. 3 illustrates a side view of the Wild Turkey Game Call without any attachments or the staking means.

FIG. 4 illustrates a side view of the turkey call.

FIG. 5 illustrates a bottom view of the Wild Turkey Game Call.

FIG. 6 illustrates a side view of the motorized compartment of the Wild Turkey Game Call.

FIG. 7 illustrates a top view of the motorized compartment of the Wild Turkey Game Call.

FIG. 8 illustrates the internal cavity of the wild turkey call.

FIG. 9 illustrates the call mechanism of the wild turkey call.

FIG. 10 illustrates the internal cavity of the turkey call showing both the call mechanism and how said mechanism is assembled.

FIG. 11 illustrates a hunter activating the Wild Turkey Game Call remotely operated from a tree stand.

### DETAILED DESCRIPTION OF THE INVENTION

While this invention is susceptible of embodiment in many different forms, there are shown in the drawings and will herein be described in detail, several embodiments with the understanding that the present disclosure should be considered as an exemplification of the principles of the invention and is not intended to limit the invention to the embodiments so illustrated. Further, to the extent that any numerical values or other specifics of materials, et., are provided herein, they are to be construed as exemplifications of the inventions herein, and the inventions are not to be considered as limited thereto.

The following description and drawings are illustrative and are not to be construed as limiting. Numerous specific details are described to provide a thorough understanding of the disclosure. However, in certain instances, well-known or conventional details are not described in order to avoid obscuring the description. References to one, or an, embodiment in the present disclosure can be, but not necessarily are, references to the same embodiment, and, such references mean at least one of the embodiments.

Reference in this specification to “one embodiment’ or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments, but not other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that the same thing can be said in more than one way.

Consequently, alternative language and synonyms may be used for any one or more of the terms discussed herein, or is any special significance to be placed upon whether or not a term is elaborated or discussed herein. Synonyms for certain terms are provided. A recital of one or more synonyms does not exclude the use of other synonyms. The use of examples anywhere in this specification, including examples of any terms discussed herein, is illustrative only, and in no way limits the scope and meaning of the disclosure or of any exemplified embodiment. Likewise, the disclosure is not limited to various embodiments given in this specification.

Unless otherwise defined, all technical and scientific terms used herein have the same meaning as commonly understood by one of ordinary skill in the art to which this disclosure pertains. In the case of conflict, the present document, including definitions will control.

The present invention comprises, in one form thereof, a can game call holder configured to tightly hold a can turkey call that emits a noise that attracts turkeys when operated. The turkey call produces a noise that simulates a female turkey when a elongated noise member is moved up and down against a noise producing member. One or more turkey call holders is coupled to a motor energized by a battery source that moves said elongated noise member up and down producing the turkey call. The motor is operated may by a remote control device that so that the Wild Turkey Game Call may be staked at a distance from the hunter and safely operated with a click of the remote.

An advantage of this invention is that the hunter can operate the game call without changing his or her firing position. When a hunter is forced to change his or her firing position to target a turkey, the movement of the hunter alerts the turkey and allows it to visual identify the turkey hunter and avoid him.

The present invention can be used to operate any other can calls that utilize the up and down motion of a elongated noise member. An advantage of this invention is that the can call can be inverted consistently producing a consistent and reliable call. An additional advantage of this invention is that the can call can be placed at a location away from the hunter allowing the hunter to position himself or herself in a tree or other location and call the game/predator to a location on the ground that is within his line of sight. Yet another advantage of this invention is that the placement of the present invention away from the hunter prevents the game from detecting the presence of the hunter. This invention allows the game/predator to be attracted to the can call and not the hunter.

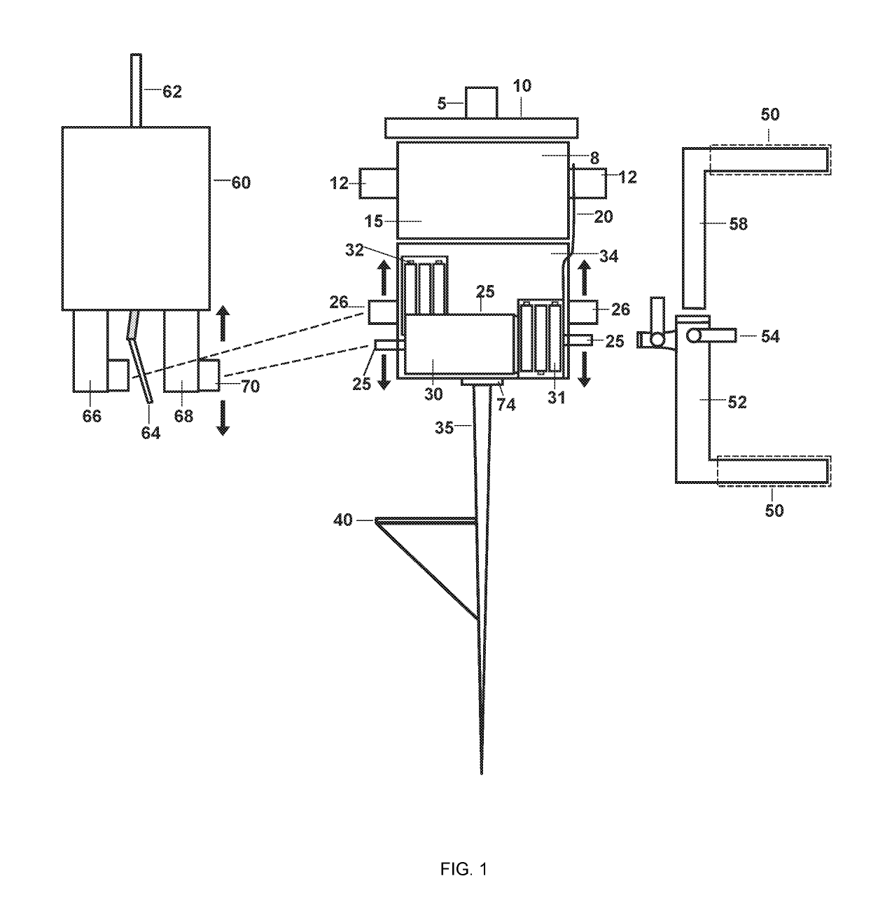

FIG. 1 illustrates the Wild Turkey Game Call with a detachable turkey call (60, 62, 64, 66, 68, and 70) and a detachable arm (50, 52, 54, 56, and 58). The Wild Turkey Game Call operates with a remote control device that is utilized by the hunter to remotely activate at least one of the motor arms 25, which causes the can call to emit a turkey call.

The Wild Turkey Game Call (FIG. 1) comprises a motorized compartment 34 with an two attachment arms 26 on each side of the exterior bottom of the motorized compartment 34. The Wild Turkey Game Call comprises a storage compartment 8 on top of the motorized compartment 34. Two female adaptors 12 are attached on the opposite sides of each other on the exterior of the storage compartment 8. Each of the two female adaptors 12 are located above the attachment arms 26. The turkey can call attaches to the Wild Turkey Game Call via a female adaptor 12 and two attachment arms 26 on the same side of the invention. Motor arms 25 attach to the turkey can call and move 64 up and down during operation of the Wild Turkey Game Call.

Stemming from the motorized compartment 34 is antenna 20. Antenna 20 is a receiver to receive the signal from the remote control device that operates the Wild Turkey Game Call.

Any commercially available can calls that operate with a pulling action may be attached via the gripping arm attachment. FIG. 1 illustrates the detachable arm that is utilized to grip can calls. The detachable gripping arm comprises two gripping means (52 and 58) that contain gripping pads 50 to securely hold a commercially available can call. 52 and 58 can be adjusted to accommodate can calls of varying sizes. 52 and 58 are locked into position via the locking mechanism 56. The detachable gripping arm locks onto the Wild Turkey Game Call via locking mechanism 56 which clamps onto motor arm 25.

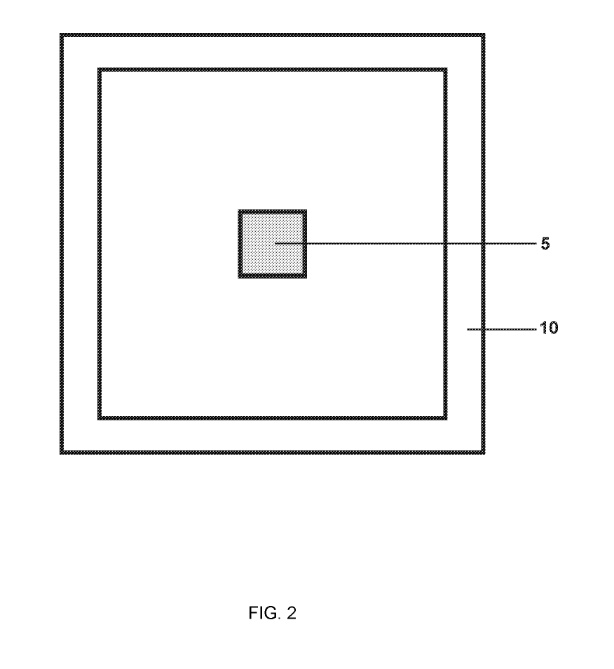

FIG. 1 illustrates the staking mechanism. The Wild Turkey Game Call can be anchored into the ground via stake 35 and 40, which are secured onto the invention via means 74. FIG. 2 illustrates a top view of the Wild Turkey Game Call. Lid 10 covers the storage compartment 8. Adaptor 5 is centered on lid 10. Adaptor 5 is utilized to attach a compatible turkey-shaped decoy.

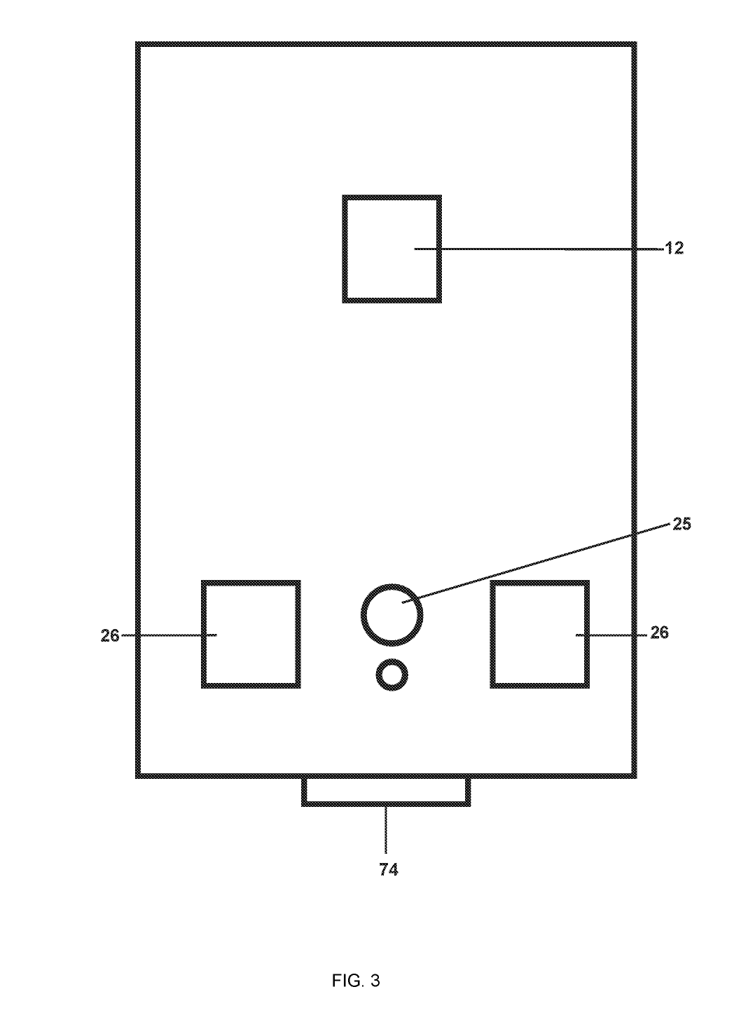

FIG. 3 illustrates a side view of the Wild Turkey Game Call. The Wild Turkey Game Call has two sides with this configuration. Each of these matching sides are opposite to each other. Female adaptor 12 and two attachment arms 26 attach to the turkey can call. Arms 26 attach to attachment arms 70 on the turkey can call. The turkey can call attaches to adaptor 12 via a male fitting located on a corresponding area of the turkey can call. Motor arm 25 extends from the Wild Turkey Game Call and mechanically moves stem 64 on the turkey can call up and down, causing said turkey can call to produce a noise to attract turkeys. Locking mechanism 74 locks staking mechanism 35 and 40 onto the Wild Turkey Game Call.

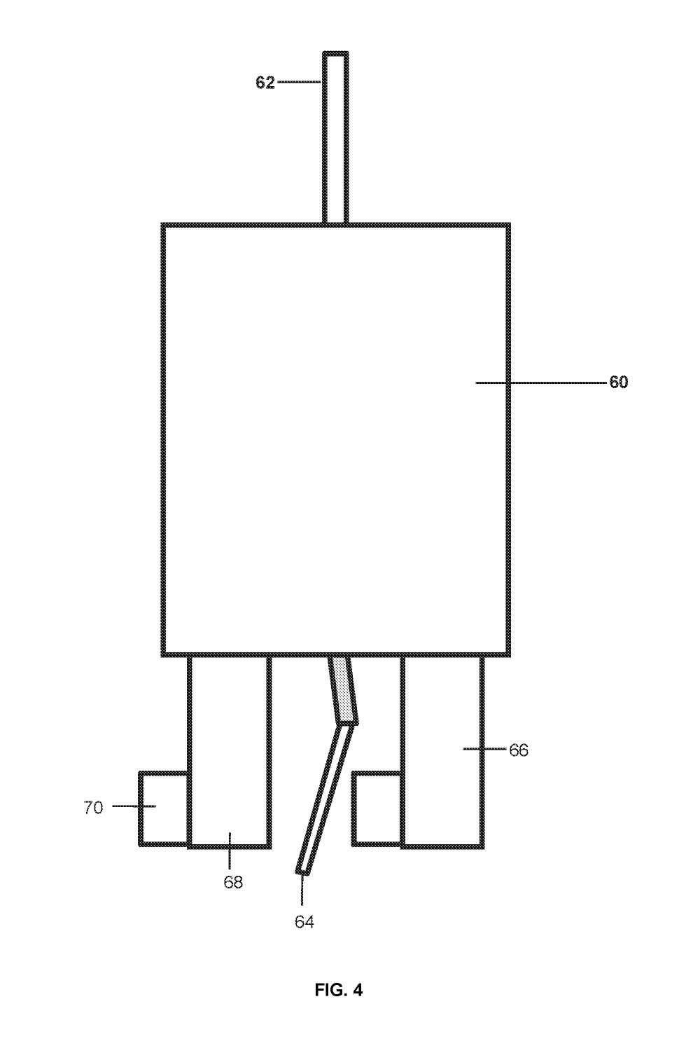

FIG. 4 illustrates the turkey can call. Stem 62 stems from the center of the body of the call 60. Stem 62 is manufactured out of wood, plastic, foam, or any other suitable material that produces a sound that attracts a turkey when rubbed against foam, plastic, rubber, or other suitable material. Stem 62 traverses the body 60 and is connected to stem 64. Stem 64 is moved up and down during operation of the Wild Turkey Game Call, which causes stem 62 to rub against a material contained within the body 60 making a noise that attracts a turkey. The material contained within the body 60 can be foam, plastic, rubber, or any other suitable material that produces the sound of a turkey when rubbed by stem 62. Stem 68 secures the attachment of the body 60 to the attachment arms 70 on the can call.

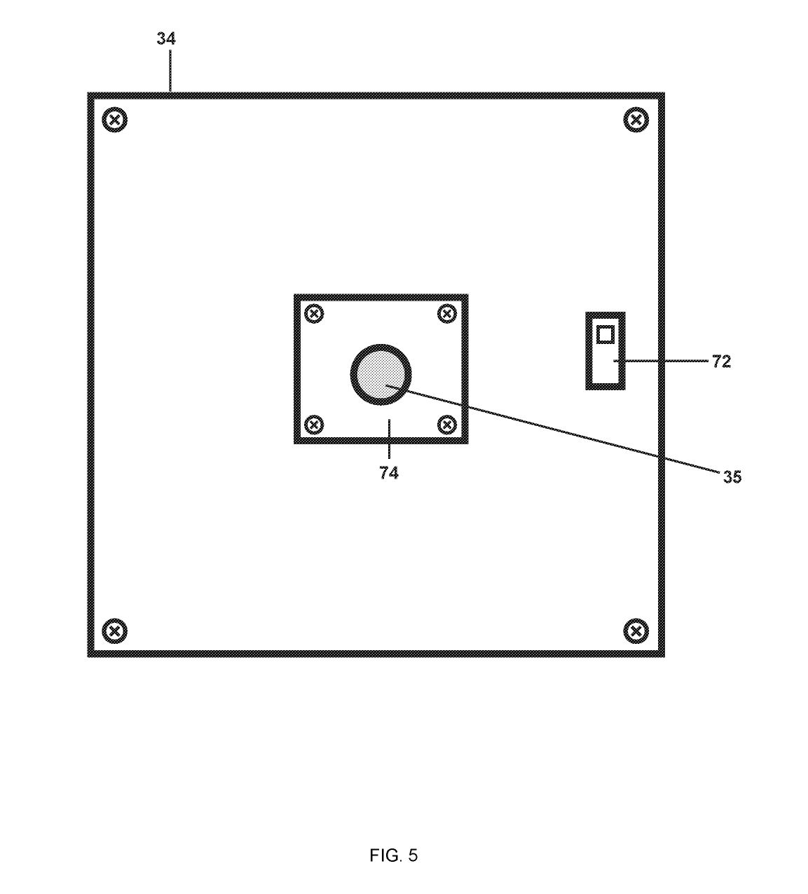

FIG. 5 illustrates the bottom view of the Wild Turkey Game Call. The motorized compartment 34 attaches to the staking member 35 via locking mechanism 74. On/off button 72 allows the hunter to turn the Wild Turkey Game Call on and off.

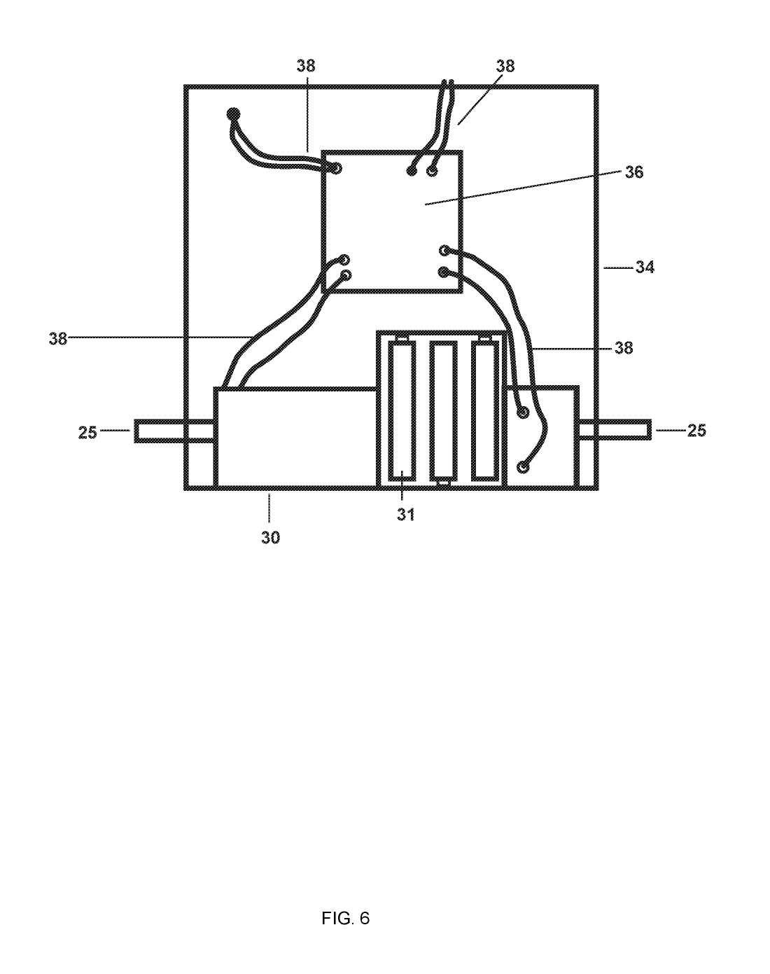

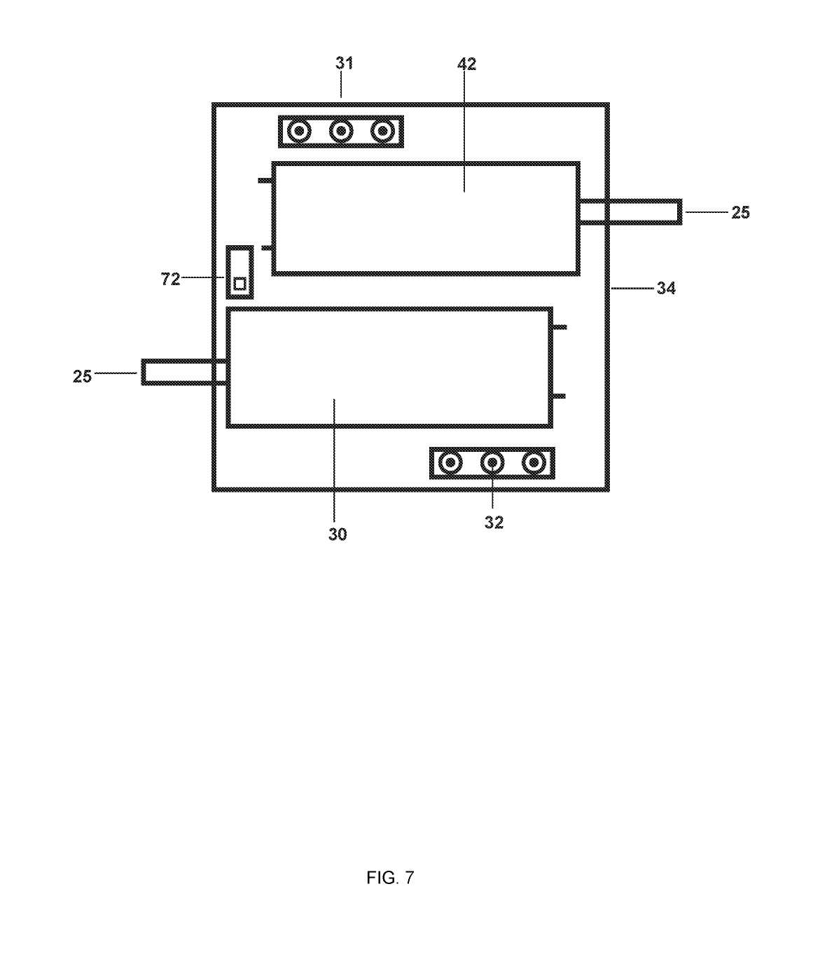

FIG. 6 illustrates the side view of the motorized compartment 34 and FIG. 7 illustrates the top view of the motorized compartment 34. The Wild Turkey Game Call comprises at least one motor 30 that operates to move one motor arm 25 up and down when signaled. The Wild Turkey Game Call may comprise a second motor 42 moves a second motor arm 25 up and down when signaled. Pairs of electrical wires 38 connect the batteries 31 to motor 30 and batteries 32 to motor 42, respectively. On/off switch 72 is located at the bottom center of the motorized compartment 34.

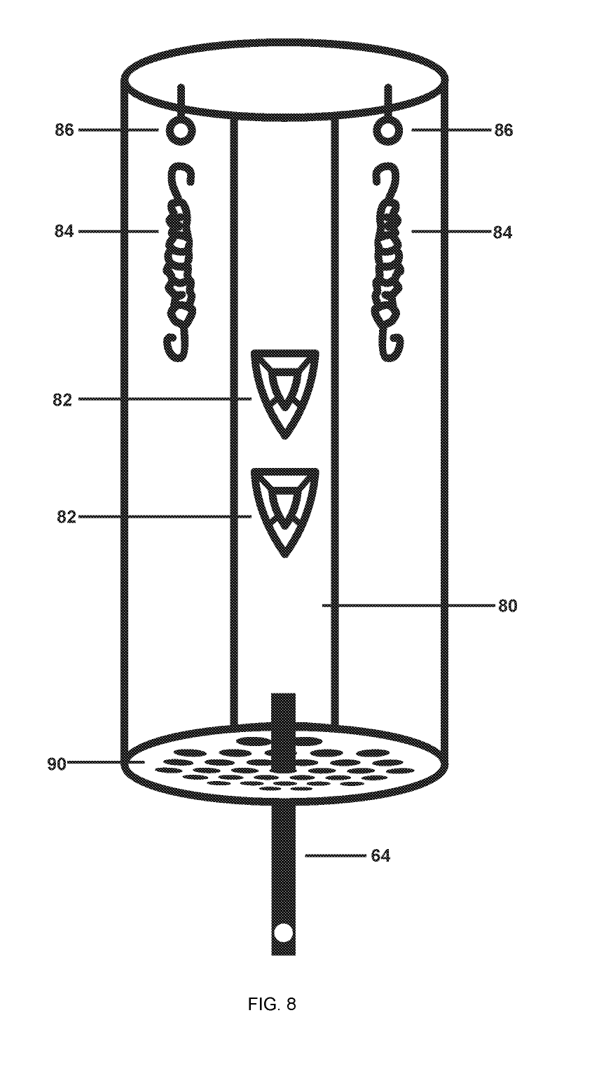

FIG. 8 illustrates the internal view of the turkey can call body 60. A turkey call mechanism 80 is centered within the can call. The mechanism 80 attaches to stem 64. One or more horns 82 are positioned within the can call. Each of two eyelet body pins 86 secure a spring member 84 to the exterior body 60 of the can call. Stem 64 extends through the bottom of the can call 90. The bottom of the turkey can call 90 contains a number of holes to emit turkey call sounds.

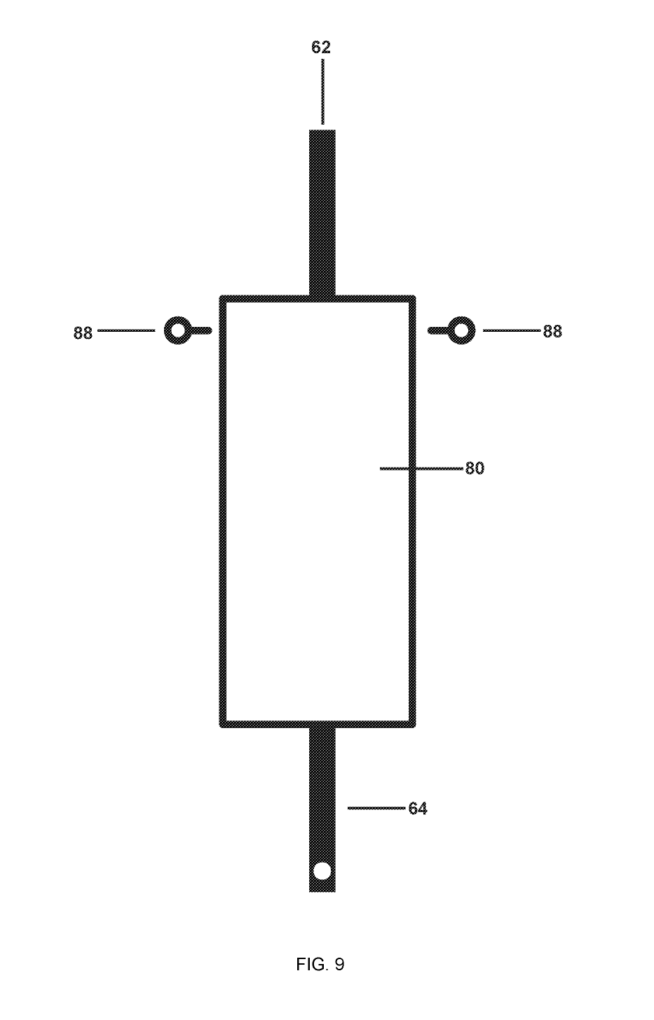

FIG. 9 illustrates the turkey call mechanism 80. 80 is composed of wood, slate or a suitable material. Two mechanism eyelet pins 88 secure the mechanism to springs attached to the exterior body 60. 80 produces the turkey call sound when it is rubbed or vibrated against. 80 attaches to stems 62 and 64.

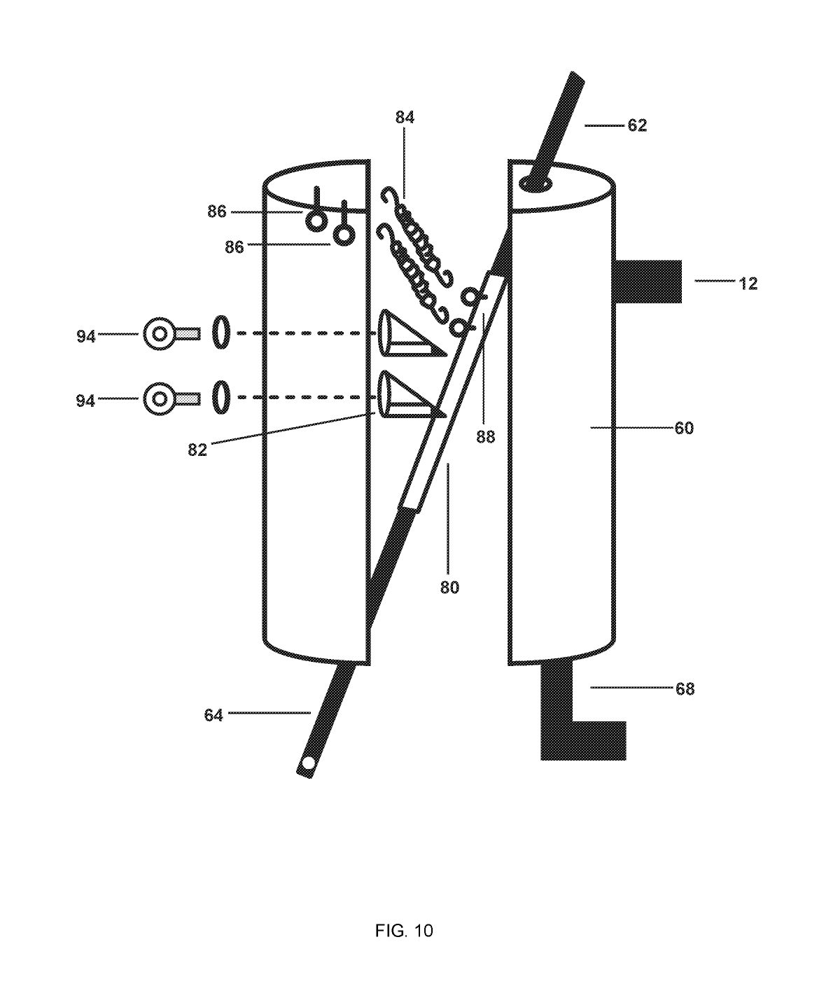

FIG. 10 illustrates an internal view of the turkey can call. The turkey call mechanism 80, which is attached to stems 62 and 64, is centered within the interior of the exterior body 60. 80 attaches to the exterior body 60 via two springs 84. Each spring 84 attaches to the mechanism 80 via an eyelet pin and an eyelet body pin 86. The springs 84 are positioned so that the mechanism 80 has a spring 84 and two eyelet pins (86 and 88) on the interior left side of the can and a spring 84 and two eyelet pins (86 and 88) on the interior of the right side of the can. At least one horn member 82 is secured to the interior of the exterior can body 60 via an exterior eyelet pin 94. The horn member 82 is composed of wood or some suitable material to produce a turkey call sound when rubbed or vibrated against the turkey call mechanism 80. Each horn 82 comes to a point where it contacts the turkey call mechanism 80 so that only this point contacts the surface of 82 when the mechanism 80 is moved up and/or down. When one horn 82 is positioned within the exterior body cavity 60 the sound of one turkey is simulated. When two horns 82 are positioned within the exterior body cavity 60 the sound of two turkeys is simulated.

The turkey can call can be manipulated by a hunter's hand moving stem 62 or 64 up and down or by attaching it to the Wild Turkey Game Call and having the Wild Turkey Game Call mechanically moving stem 62 or 64 to create the turkey attracting noises.

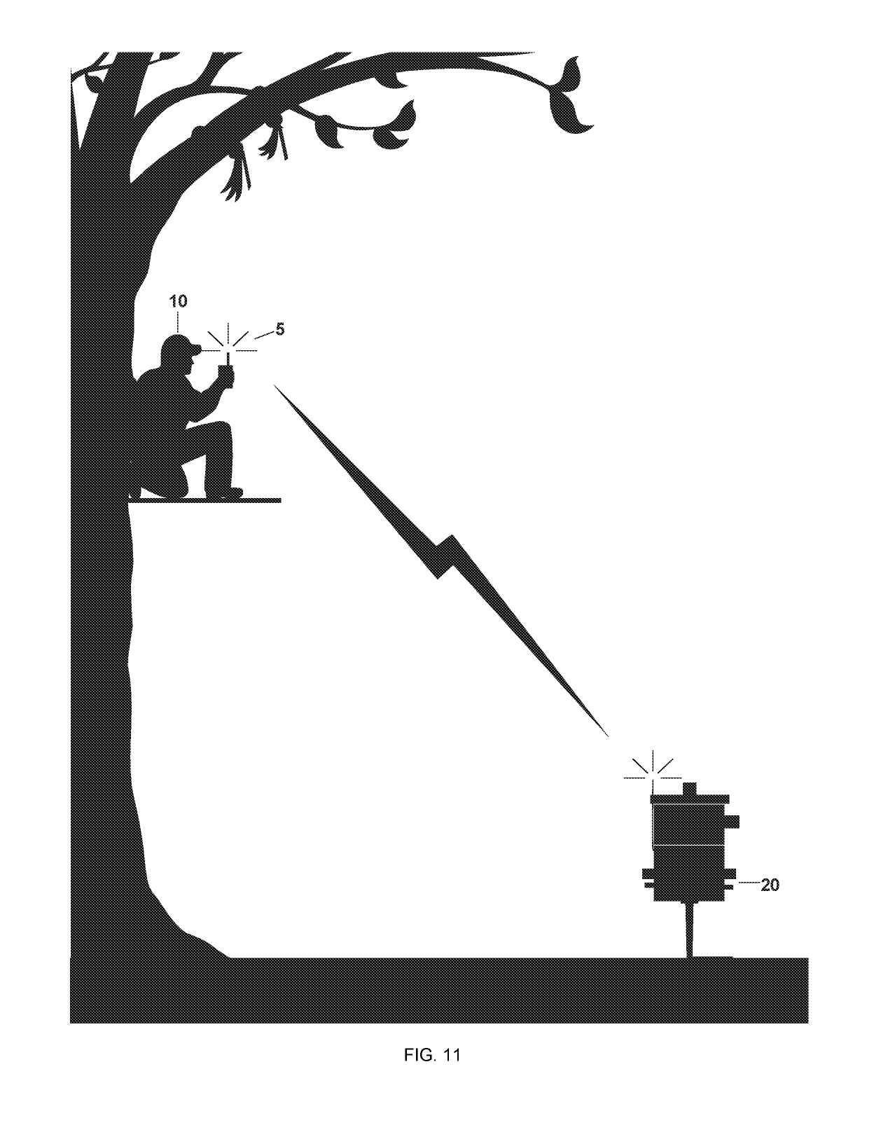

FIG. 11 illustrates the use of the Wild Turkey Game Call by a hunter. Following attachment of at least one turkey can call or other suitable can call, the Wild Turkey Game Call can be pushed into the ground via stake mechanism 35 and 40 into the desired location. Remote control 100 allows the turkey hunter 90 to activate the Wild Turkey Game Call via antenna 20 and produce can call from a remote location such as a tree stand positioned in a tree.

I hereby claim:

1. A game call that produces a sound simulating a wild turkey noise comprising:
an outer body that houses a turkey mechanism, wherein said turkey mechanism comprises a stem member that moves up and down through the outer body; wherein said stem member frictionally engages two or more sound producing members to produce the sound simulating two or more turkeys.

2. The device of claim 1 wherein said outer body includes a member to attach said device to a game call holder.

3. (canceled)

4. A game call holder comprising:
a motor having a shaft, said motor rotating said shaft when energized;
a power source for energizing said motor,
at least one game call that mechanically produces an animal noise by causing two member to frictionally engage may be reversibly coupled to said shaft; and
a remote control selectively activating said power source.

5. The game call holder of claim 4, further comprising a housing, at least one of said motor and power source being disposed within said housing, said housing configured for mounting into the ground.

6. The game call holder of claim 4, wherein said motor and said power source are disposed within said housing, said shaft extending therefrom.

7. The game call holder of claim 4, further comprising a housing, at least one of said motor and power source being disposed within said housing, said housing configured for mounting onto an object.

8. The game call holder of claim 7, wherein said motor and said power source are disposed within said housing, said shaft extending therefrom.

9. (canceled)

10. The game call holder of claim 4 wherein said game call holder includes a clamp to reversibly attach said game call.

11. The game call holder of claim 4 wherein two game calls are coupled to said shaft.

12. (canceled)
